(19) United States
(12) Patent Application Publication
(10) Pub. No.: US 2008/0163761 A1
(43) Pub. Date: Jul. 10, 2008

(54) Unit For Moulding Food Products, In Particular For Cooking Ham

(75) Inventors: Jean-Claude Champalaune, Saint-Meen-le-Grand (FR); Yvon Corveller, Pontivy (FR)

Correspondence Address: PAULEY PETERSEN & ERICKSON, 2800 WEST HIGGINS ROAD, SUITE 365, HOFFMAN ESTATES, IL, 60195, US

(73) Assignee: KAUFLER, Loudeac (FR)

(21) Appl. No.: 11/885,461

(22) PCT Filed: Feb. 28, 2006
(86) PCT No.: PCT/FR2006/000452

§ 371 Date: Aug. 31, 2007

(30) Foreign Application Priority Data
Mar. 2, 2005 (FR) 0502100

(51) Int. Cl. A23P 1/00

(52) U.S. Cl. 99/426

(57) ABSTRACT

A unit for molding food products, in particular for cooking ham is provided. The unit includes a set of parallel horizontal troughs. The troughs have a downwardly-oriented base and an upwardly-oriented opening and are fixed to one or more supports that enable units to be stacked on top of one another. A set of cover elements extend beneath the set of troughs such that, when units are stacked, a cover element is engaged in the trough opening of the subjacent unit. The unit also includes a built-in spring lock which, by application of a downward pressure, solidly connect the unit to a similar unit in an automatic manner in order to ensure that the respective support is fully supported. Subsequently, the lock can be retracted to separate two units from one another and to unstack same. Units can be joined by such automated locking in order to form a stable stack. The unit is suitable for use in the agri-food industry.

### BACKGROUND OF THE INVENTION

1. Field of the Invention

The invention relates to a unit for molding food products, in particular for cooking ham.

More specifically, the invention relates to a molding unit of the type comprising a set of molds in the form of troughs arranged horizontally, side by side and parallel to one another, their bases being downwardly oriented and their openings being upwardly oriented, this set of molds being fixed to support means which enable the units to be stacked on one another.

2. Discussion of Related Art

Units of this kind are described, for example, in FR-A-2 601 653 and FR-A-2 672 270. The troughs are fixed to vertical plates at each of their two ends.

According to FR-A-2 601 653, these plates form the two sides of a frame structure, equipped with four legs (two for each plate) adapted to enable the units to be stacked.

According to FR-A-2 672 270, the vertical end plates are shaped by bending in a specific way which gives them a cross section enabling stacking.

After stacking, the troughs of two superimposed layers are positioned at a certain distance from one another vertically, in order to permit the flow of air around the different molds inside the cooking compartments, or in other product processing stations. Since a plurality of molds is grouped in a single set, the operations carried out on the products are facilitated and the efficiency of the operations is improved.

Thus, in the case of cooking ham, it is possible to simultaneously manipulate the set of molds that form a unit. This manipulation, carried out in particular for the stacking and unstacking of the units, is very suitable for automation, using mechanical manipulators. A pair of arms is generally used for this purpose. These arms are used for grasping the unit from below while supporting the troughs.

When a stack of units has been formed, the products contained therein can be processed simultaneously, for example by cooking them inside a suitable cooking compartment. Such a stack has relatively small overall dimensions, making it possible to operate with high efficiency.

It has also been proposed that each unit of this type be provided with a set of cover elements. Thus each trough can be associated with a cover element which extends under its base and is fixed thereto. When the units are stacked on one another, each cover element engages in the opening of the trough belonging to the underlying unit with which it is aligned.

It is possible for a bottom unit of the stack to have no cover elements, or to have cover elements by means of which it rests directly on a support, for example a transfer carriage; the top unit receives special cover elements carried by a structure without molds.

Such molding units, which may or may not have cover elements, are marketed by the applicant under the trade name “Polymodule” (registered trademark).

When the units are provided with cover elements, the aforementioned handling arms again grasp the molding units from below, but in this case they support not the bases of the troughs, but the cover elements fixed under the bases. The use of covers is advantageous, in particular, for cooking ham, since the ham is confined in a well defined volume in which it is kept under a certain pressure which eliminates shortages of material and determines its final shape.

However, it is desirable for the pressure exerted by the covers to be accurately controllable on an individual basis. With devices of the kind described above, this pressure is highly random, since it depends on the volume of each piece of ham (or other product) placed in the mold. This is because the covers of one unit initially press on the product or products having the greatest volume in the underlying unit, and these products are therefore subject to a greater degree of flattening than the others. On the other hand, there is a risk that products with a small volume will not be sufficiently compressed. Since, in practice, the actual volumes of the products placed in the molds inevitably lie within a certain range of tolerances, in spite of the preliminary weighing of these products, they will be subjected to pressures which may vary widely.

Also, products contained in units placed at the bottom of a stack will be subjected to greater pressures than products in upper units of the stack, since they have to support the full weight of the units positioned above them. Finally, the support of one unit by an underlying unit, which should be established solely by the trough supports, is not provided in correct conditions, since the areas of the covers—or of some covers—by which they are supported on the underlying products tend to prevent the correct support of the supports by one another. This gives rise to unstable stacking, which is unfavorable to various operations, in particular to the transfer of the products.

EP 0 722 663 describes a molding unit of the aforementioned type, with multiple molds, by means of which, after several units have been stacked, the trough supports are supported on one another, while each product contained in a mold, for example a piece of ham, is individually subjected to a controlled pressure, which is applied to it by the cover element located above it. For this purpose, each cover element is individually movable in the vertical direction, over a limited path, with respect to the trough with which it is associated, such as through a resilient system such as a set of springs tending constantly to separate it from the base of the trough to push it back downward.

Such a unit is highly suitable for mechanized manipulation, since the molding units can be handled by conventional support and transfer members, without difficulty and with a high degree of stability.

For individual manipulation of units, in particular for stacking them before cooking and for unstacking them after cooking, use is generally made of a gripping and handling robot such as that distributed by the applicant under the name “Autostacker” (registered trademark). For this purpose, the movable head of the robot has gripping fingers, for example two pairs of fingers for engaging in ad hoc receiving orifices provided in the vertical plates positioned at the ends of the troughs.

The device described by the previously cited document FR 2 672 270 has two superimposed rows of three orifices, formed in said plates which consist of sides bent in such a way as to allow stacking. For gripping a unit, only the two end orifices of the upper row are used (making a total of four). However, these orifices—including the central orifice—also have the function of promoting the flow of the fluids used for the thermal processing of the products. The presence of a lower row of orifices which faces the upper row of the orifices of an underlying unit allows this flow within the stack.

This kind of device is generally satisfactory. However, a problem may persist of improper support of the units on one another, in particular when the food products, particularly meat, contained in the troughs have relatively dissimilar volumes and/or shapes, lying outside a precise range of tolerances.

There is a risk that projecting parts of a product will prevent a cover from being pushed down correctly, even if the cover is movable and stressed by springs as specified in EP 0 722 663. This adversely affects the verticality and equilibrium of the stack.

To overcome this problem, it is known to use lateral straps with locking levers. The straps, of which, for example, there may be four (two on each side of the stack), are positioned vertically and attached to the top unit and bottom unit of the stack and are placed under tension. The aforementioned orifices for gripping and for processing fluid flow are used, for example, for the attachment of these straps.

The tension must be sufficient to flatten surplus projecting material. This makes the placing of these straps difficult. In addition, at the end of the processing, the straps have to be removed.

Such operation generally cannot be automated and is time-consuming and tedious. Furthermore, during thermal processing, particularly cooking, the straps may expand and slacken, making the stack again unstable at the end of the processing.

Finally, the straps used are generally made from woven fibers which can create bacterial pockets, incompatible with the hygiene constraints applicable to the food processing industry.

FR-A-2 839 044 proposes a device for fastening together a plurality of units (called containers). This device has a pair of fixing elements connected solidly to containers positioned at the ends of the stack and linked by a resiliently deformable element which can be placed under tension by means of a locking lever. A pair of similar devices is used on two opposite sides of the stack, in order to keep it under tension.

Although this kind of device resolves the problem of bacterial pockets related to the presence of woven fiber straps, it cannot overcome other difficulties mentioned above, in particular the impossibility of automating the stacking and unstacking operations, since the placing and removal of these fastening devices can only be carried out manually.

### SUMMARY OF THE INVENTION

An object of the invention is to resolve at least some of these problems.

As described above, the invention proposes a unit for molding food products, in particular for cooking ham, which has a set of molds in the form of troughs positioned horizontally, side by side and parallel to one another, their bases being downwardly oriented and their openings upwardly oriented, this set of molds being fixed to a support which enables units to be stacked on one another. The unit may also be solidly connected to a set of cover elements. The number of these elements preferably are equal to the number of troughs. Each cover element extends below a base of a trough, such that when the units are stacked on one another, each cover element engages in the opening of the trough belonging to the underlying unit with which it is in alignment.

An object of the invention is at least in part achieved in that this unit has a built-in spring lock which acts automatically, by application of a downward vertical pressure, to solidly connect the unit to a similar unit lying below and/or above it, in order to ensure that the respective support thereof is fully supported. The lock can subsequently be retracted in order to detach two units from one another and to unstack them.

Since the lock is built into the unit rather than being separate, automated handling of these units is possible.

During the downward movement of a unit onto an underlying unit, which is advantageously provided by the head of a gripping and handling robot, pressure (which may be very high) is exerted in a downward direction, thus compressing any excess product, after which the locking takes place. The two units are then solidly connected, fully and irreversibly to one another.

If the units have cover elements resiliently movable with respect to the troughs with which they are associated, as is the case, in particular, with the units described in EP 0 722 663 or EP 0 867 140, the application of this pressure also has the advantage of properly compressing the springs acting on the cover elements, such that these elements can fully provide the compensation required of them.

When a set of units has been stacked and assembled by locking, a perfectly vertical and stable stack is obtained. Any expansion which may occur during subsequent thermal processing has no effect on the securing of these units to one another in the stack.

Additionally, according to a certain number of advantageous, but not limiting, embodiments of the invention:
such a built-in spring lock comprises movable locking fingers which are stressed by a spring and which can, under the action of this spring, occupy a first position, called the locking position, in which they interact with a stop element of the similar unit located below and/or above it, to ensure that the two units retain one another in the vertical direction, and a second position, called the retracted position, in which they are moved away from the stop element and allow the two units to be detached from one another;
these movable locking fingers are pivoting levers;
the stop elements are built into the support member and the movable locking fingers have a stop surface area which can bear against a stop element of the similar unit located above it in order to keep the unit pressed against it when the movable finger occupies its locking position;
there are four movable locking fingers, which are substantially arranged in a rectangular formation when seen from above;
these fingers project slightly toward the outside of the unit when they occupy their locking position, and they are retracted by pushing toward the inside of the unit, for example by means of movable unlocking pins fitted on a manipulator robot;
the support comprises a pair of support plates fixed transversely to each end of the set of troughs. These plates are bent in such a way that their cross section comprises an upper vertical rectilinear part, a first substantially horizontal outwardly oriented support area, a lower vertical rectilinear part, a second substantially horizontal inwardly oriented support area, which is narrower than the first support area, and a bottom end portion oriented obliquely upwardly and outwardly. The movable locking fingers are mounted on the upper parts of these plates. The springs tend to move them outward over a limited path. The bases of the plates, at the level of the bottom end portion, act as stop elements for the locking fingers of the underlying ends;
each of the locking fingers has a shaped outer surface forming a ramp which can slide against the base of the plates of the unit located above it, at the level of their bottom end portion, for progressively and temporarily pushing the locking fingers back toward the inside, in order to retract them, when the supporting state is established by a vertical downward movement of this unit, resulting in automatic locking;
openings are formed in the lower parts of the plates. These openings are positioned, when the unit is correctly placed on an underlying unit, opposite the locking fingers of the latter, thus allowing the passage of unlocking members, such as pins which can move horizontally and transversely with respect to the plates;
the unit has four locking fingers in a rectangular arrangement, in the vicinity of its corners, outside the set of troughs.

### BRIEF DESCRIPTION OF THE DRAWINGS

Other features and advantages of the invention will be made clear by the following description thereof which refers to the attached drawings, which represent in a non-limiting way a possible embodiment of the invention.

FIGS. 1 and 2 are views taken, respectively, from the side (transversely with respect to the troughs) and from the front (parallel to the troughs), and in partial section, of a molding unit according to one embodiment of the invention.

FIG. 3 is a view of this unit.

FIG. 4 is a detailed view in cross section and from the front, showing the spring locking means in their locking position.

FIG. 5 is a view similar to that of FIG. 4, showing the operation of unlocking by retraction of these spring locking means.

FIGS. 6 and 7 are detailed views showing a locking finger from the front and from above respectively, in its locking position.

FIGS. 6A and 7A are views similar to the preceding ones, but now with the finger retracted.

FIGS. 8 and 8A are views from above in section along the horizontal plane identified as VIII-VIII in FIG. 6, the finger occupying a locking position and a retracted position respectively.

FIG. 9 is a view from the right of FIG. 6.

FIG. 10 is a schematic view from below of a frame forming the gripping head of a manipulator robot used for stacking and unstacking units according to one embodiment of the invention, the gripping members occupying an inactive position.

FIG. 11 is a similar view of the same frame, with the gripping members in the active position.

FIGS. 12 and 13 are front views of the frame, corresponding to the positions of FIGS. 10 and 11 respectively.

FIGS. 14A to 14F are detail views which show in a highly schematic way an operation of stacking one unit on another.

### DETAILED DESCRIPTION OF THE INVENTION

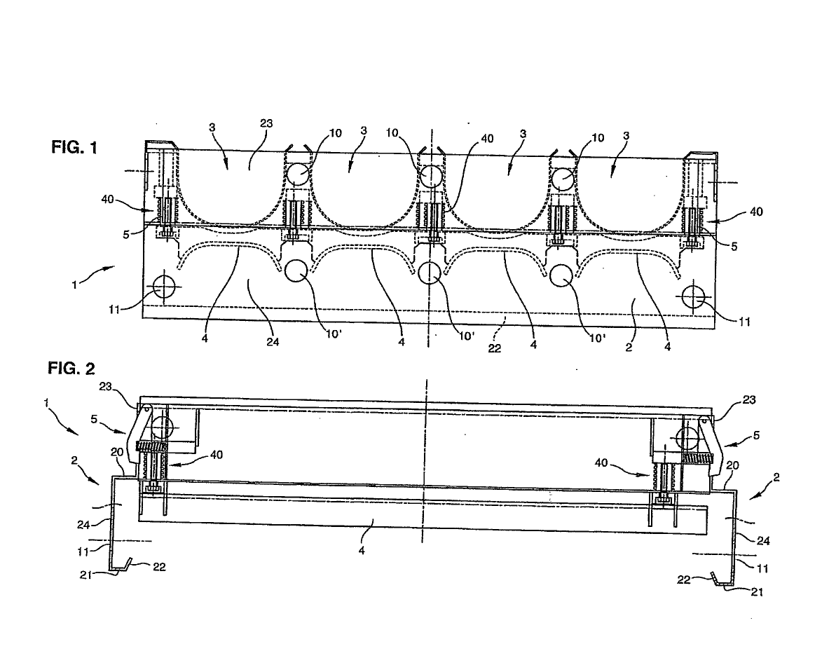

The unit shown in FIGS. 1 to 3 is a unit useful for molding and cooking ham with movable covers stressed by springs, which is of the general type described in EP 0 722 663, to which reference may be made if necessary, and which is marketed by the applicant under the trade name “Polymodule Compensateur”, which includes the registered trademark “Polymodule”.

The unit 1, such as made from stainless steel, comprises a support or support means 2 comprising or consisting of a pair of plates or sides, with multiple bends, fixed to the ends of a set of four troughs 3 acting as molds which receive the ham.

Each of these troughs or molds, which are open at the top, has an approximately semicircular wall, the shape of which determines the shape of the slabs of ham to be produced. The sides 2 are positioned transversely and symmetrically at the ends of the troughs, to which they are fixed by welding. The sides have a configuration enabling the units to be stacked on one another, this well-known configuration being detailed in FR-A-2 672 270, to which reference may also be made if necessary.

The cross section of a plate 2 (see FIG. 2) has a vertical rectilinear upper part 23, a first substantially horizontal outwardly oriented support area 20, a lower vertical rectilinear part 24, a second substantially horizontal inwardly oriented support area 21, which is narrower than the first support area 20, and a bottom end portion 22 oriented obliquely upwardly and inwardly.

The support area 21 is adapted to be placed on the support area 20 of an underlying unit within a stack.

The unit 1 is also solidly connected to a set of cover elements 4. The number of cover elements in a preferred embodiment is equal to the number of troughs, which is four in this case, and each cover element extends below a trough base, in such a way that, when units are stacked on one another, a cover element is engaged in the opening of the trough belonging to the underlying unit, with which it is aligned.

The cover elements are vertically movable, over a limited path. A set of four helical springs 40 tends to constantly push the cover elements downwards, in an arrangement proposed by EP 0 722 663, which will not be explained again in this text in order to avoid unnecessary complication of the present description, especially since the invention is equally applicable to units whose cover elements are fixed with respect to the troughs.

In the illustrated embodiment, the cover elements have a curved shape, the convexity of which faces downward, which determines the shape of the upper part of the slab of ham.

In a way which is known, particularly from the previously cited FR 2 672 270, two superimposed rows of three circular orifices 10 and 10′ respectively are provided in the bent sides 2. One of these rows (10) is formed at the level of the upper part 23, and the other (10′) is formed at the level of the lower part 24. The orifices 10 are positioned between two adjacent troughs. The orifices 10′ are positioned between two adjacent cover elements.

The two end orifices 10 of the upper row (making a total of four) are intended to receive gripping members fitted on a handling robot. However, these orifices 10—including the central orifice—also have the function of promoting the flow of the fluids used for the thermal processing of the products. This also explains the presence of the lower row of orifices 10′, each of which faces an orifice 10 of the underlying unit, in order to allow this flow within the stack.

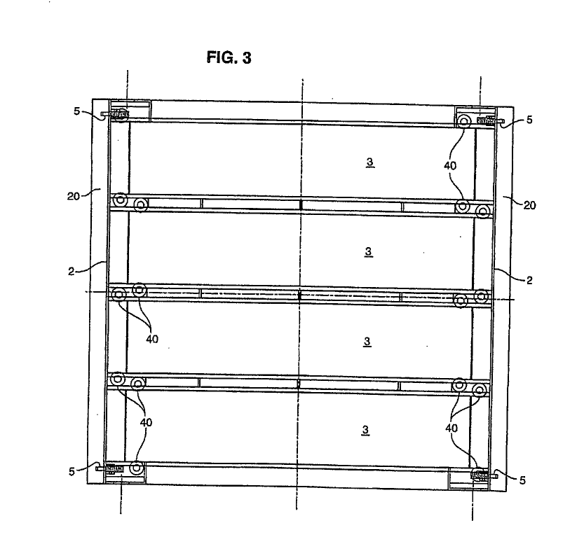

According to a preferred embodiment of the invention, the unit 1 has at least one built-in spring lock or locking means which, as described below, enables it to be connected solidly to a similar unit located above it. This lock is capable of being disabled (or retracted) to allow the detachment of the two units from one another, and consequently their unstacking. In a preferred embodiment such locking is carried out on each of the two sides 2. The lock may comprise a set of four movable locking fingers 5 which, when seen from above, are substantially arranged in a rectangular formation, at the four corners of the unit which, when seen from above, has a generally rectangular or square shape (see FIG. 3).

A finger 5 includes a substantially vertical pivoting lever, forming a locking catch, pivoted in its upper part about a horizontal shaft 500 carried by a support 25 fixed against the inner face of the upper part 23 of the plate 2, immediately adjacent to a lateral trough 3 (outside this trough). The support 25 includes a pair of small vertical plates, perpendicular to the part of the plate 23, which act as flanges holding the shaft 500, and the lever 5 can move between these plates. The lever may also take the shape of a relatively thin vertical small plate (see FIG. 9), which can pivot in a longitudinal vertical plane (parallel to the longitudinal axis of the troughs).

A vertical slot 200, slightly wider than the finger 5, is formed in the upper part 23 of the side 2, between the flanges 23, facing each finger 5. This slot is positioned to allow the lever to partially penetrate it and project outwardly.

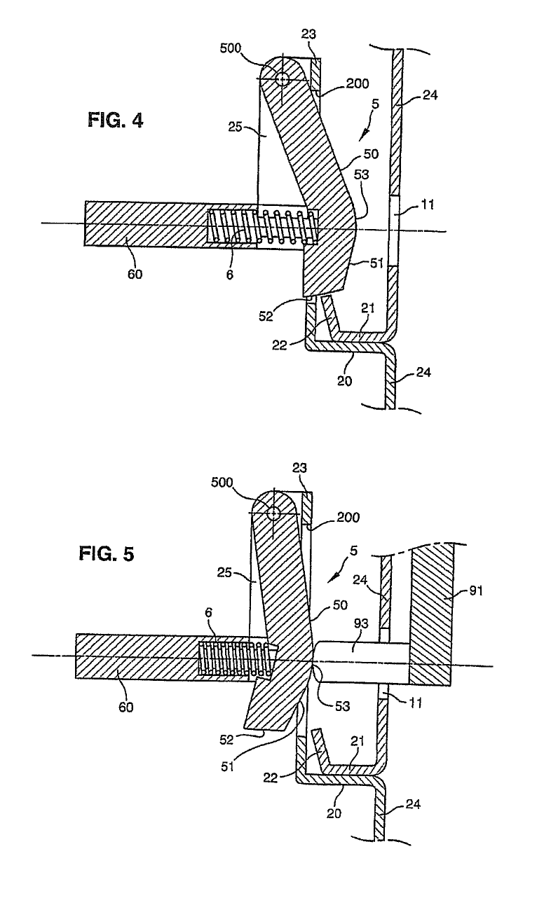

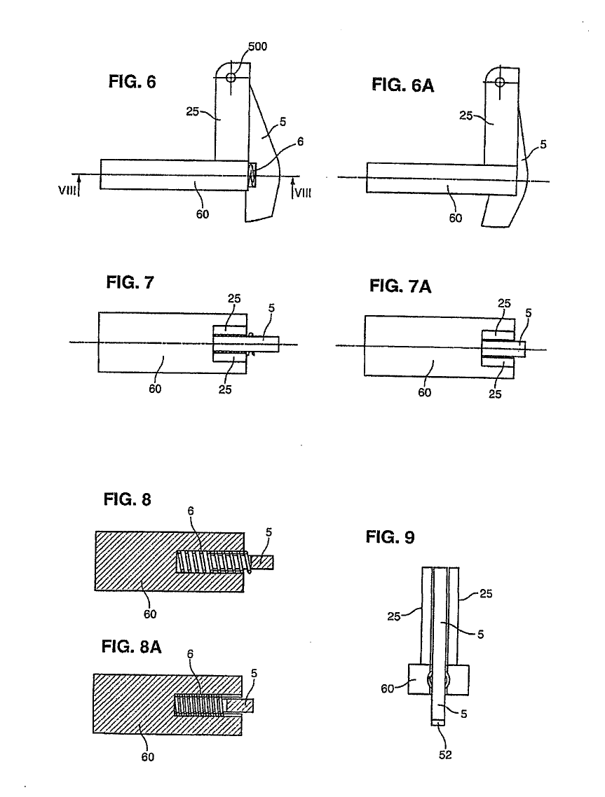

A helical compression spring 6 housed in a fixed support barrel 60 (connected solidly to the flanges 25) tends to constantly pivot the lever 50 outwardly, into what is called its locking position, as shown in FIG. 4. The upper edge of the slot 200 acts as a stop, limiting this outward movement of the lever.

The finger 5 has a shaped outer edge having two approximately rectilinear parts 50 and 51 forming a “V” with a very wide obtuse angle whose vertex points outward, and which are connected by a rounded transition area 53. In its lower part, the finger 5 has a slightly curved convex edge 52 in center of curvature substantially coincides with the shaft 500. This lower edge 52 of the lever forms a stop surface area which can bear against the edge of the part 22 of the plate of a similar unit located above the unit in question, to keep it pressed against it when the finger 5 occupies its locking position, as shown by FIG. 4. When it is pushed inward by an appropriate unlocking member, such as the pin indicated by 93 in FIG. 5, such as carried by a horizontally movable support 91, the lever 5 pivots in opposition to the return spring 6, to occupy a retracted position in which the stop area 52 has released the part 22 which it previously trapped.

An orifice 11 (similar to the orifices 10, 10′) formed in the wall of the lower main part 24 of a unit allows the passage of this member to actuate the locking finger 5 of the underlying unit. In a unit 1, each finger 5 is therefore associated with an orifice 11 positioned below it (in the same longitudinal vertical plane).

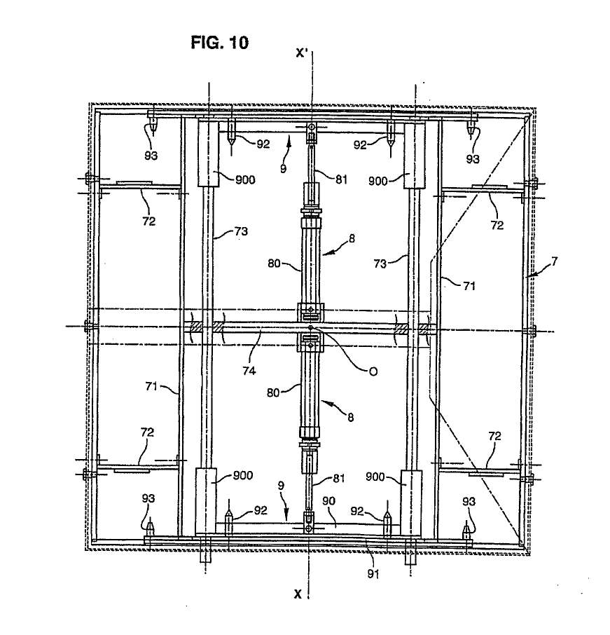

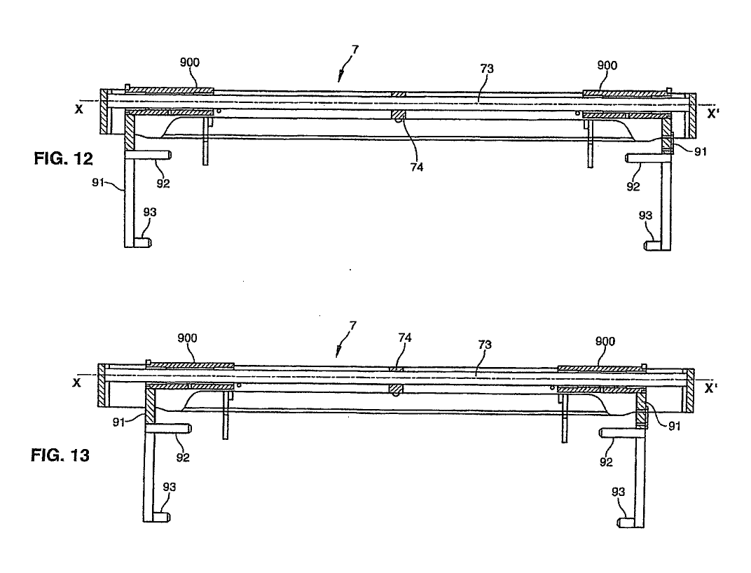

The gripping and handling head 7 shown in FIGS. 10 to 13 takes the form of a horizontal rectangular frame intended to be fixed to the arm of a manipulator robot (not shown) of a known type. This frame has a symmetrical configuration about a central point O. The frame is stiffened internally by longitudinal members 71 and transverse members 72, and by a central cross piece 74.

The frame's transverse sides support a pair of longitudinal guide rods 73, of circular section for example, which extend symmetrically about a central axis X-X′, passing through holes formed in the cross piece 74. The cylinders 80 of two double-acting pneumatic actuators 8, positioned back-to-back, are fixed coaxially on the axis X-X′, one on each side of the cross piece.

A slide block 9 comprising a first vertical and transverse plate 90, provided with a pair of sleeves 900 which can slide on the guide rods 73, is fixed to the end of each actuator rod 81.

A second vertical and transverse plate 91 provided with a pair of gripping fingers 92 and a pair of unlocking pins 93 is fixed on the outer face of each plate 90. The fingers 92 of a pair are closer to one another and are located at a higher level than the fingers 93. This is because, as shown in FIG. 1, when the gripping head is placed around the unit 1, the gripping fingers 92 are positioned facing the lateral orifices 10 of the upper row, while the unlocking fingers 93 are positioned facing the orifices 11.

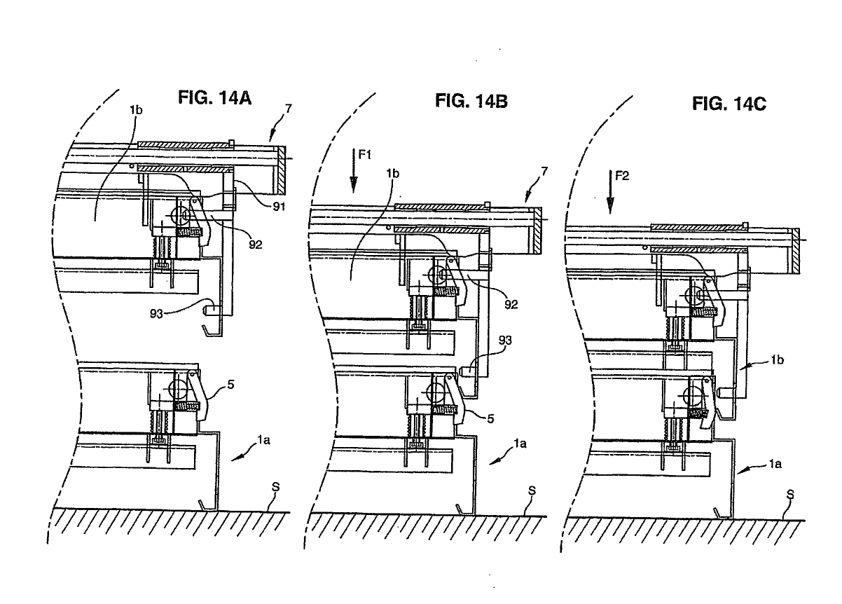

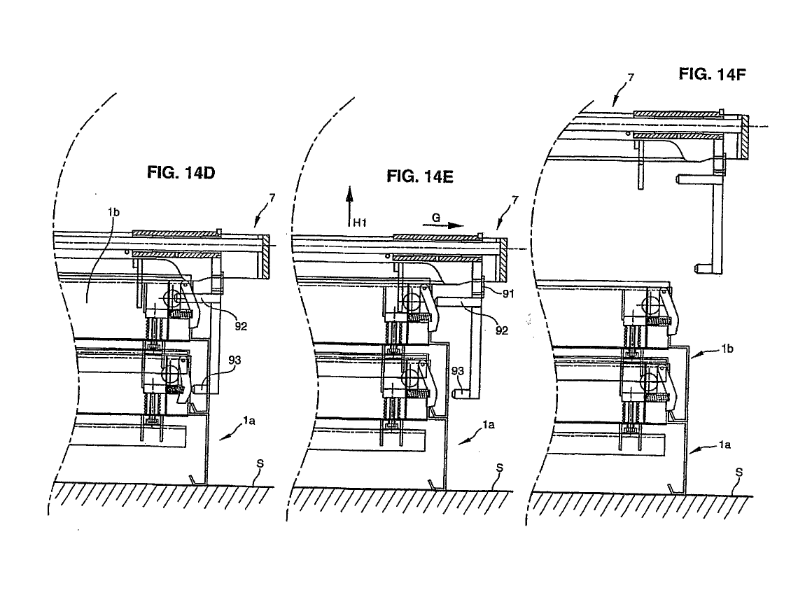

With reference to FIGS. 14A to 14F, a description will now be given of an operation of stacking a unit 1b on a unit 1a which has already been placed on a support S.

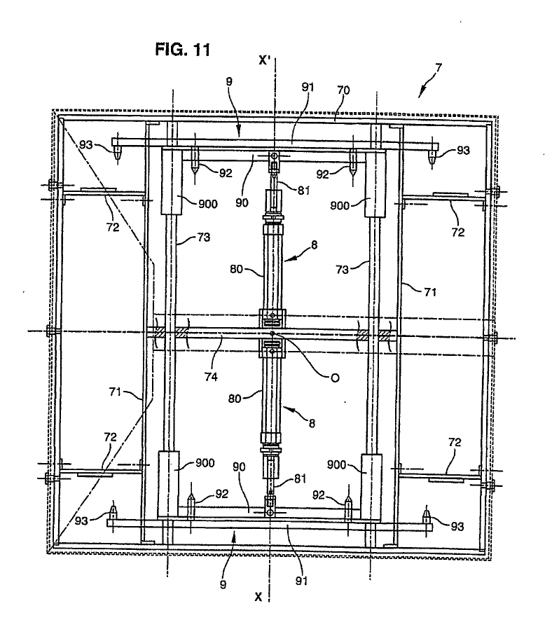

The unit 1b is retained by the frame 7 by the four gripping fingers 92, each of which is engaged in an orifice 10. The actuators 8 are in the retracted position corresponding to the position shown in FIG. 11, with the slide blocks 9 brought toward one another. At the same time, because of this movement toward one another, the pins 93 are also positioned in the orifices 11. The frame 7 maintains a horizontal position at all times during its movements.

By means of the robot arm, the frame and the unit 1b which it supports are suitably positioned above the unit 1a, and the assembly is lowered as indicated by the arrow F1 in FIG. 14B.

The inclined lower parts 22 of the sides 2 of the unit 1b then come into contact with the areas 50 of the locking fingers 5 of the underlying unit 1a, because these fingers project outward under the action of the springs 6. As the downward movement continues, the oblique wall of this lower part progressively pushes the fingers 5 inward, by a ramp (or cam) action. The fingers pivot about the shaft 500 toward their retracted position, compressing the springs 6.

During this movement, indicated by the arrow F2 in FIG. 14C, the robot head develops a relatively high downward pressing force. As a result, the forces of the springs 40 acting on the cover elements of the unit 1b are counteracted and any excess thickness of meat which may be present in the unit 1a is flattened, so that each product is appropriately compressed within its trough. This downward movement combined with a high degree of compression causes the two horizontal flat parts 21 of the plates 2 of the upper unit 1b to be fully supported on the equally horizontal flat parts 20 of the lower unit 1a.

At this stage, the part 22 has passed below the lever 50, its upper edge having passed over the ridge separating the areas 51 and 52. However, the pin 93 is then pressed against the convex rounded portion 53 of the lever.

The actuators 8 are then operated to cause their extension. This results in the separation of the slide blocks 9 from one another and causes the fingers 92 and the pins 93 to move out of the orifices 10 and 11 respectively in which they were engaged. This movement is indicated by the arrow G in FIG. 14E.

The lengths of the gripping fingers 92 and the unlocking pins 93 respectively are advantageously determined in such a way that the gripping fingers are still in engagement with the unit 1b. This enables the unit to be kept pressed against the underlying unit 1a, at the point when the pins 93 are sufficiently separated to allow locking. The spring 6 expands and pushes the lever 50 back outward until it bears against the upper edge of the slot 200. Locking is thus achieved.

The stop area 52 is positioned immediately above the upper edge of the part 22 and thus ensures that the two units 1b and 1a are connected solidly in a position corresponding to the illustration of FIG. 4. The two units are connected solidly, fully and irreversibly to one another.

The frame 7 can be detached from the unit 1b and raised again (arrow H, FIG. 14E). It is then available (FIG. 14F) for the collection of another unit.

Stacking continues in the same way, by placing a third unit on the unit 1b, and so on, until the desired stack is formed. When a series of units has been stacked and assembled by locking, the result is a perfectly vertical and stable stack which can easily be transferred into a cooking compartment.

Expansion which may occur during subsequent thermal processing has no effect on the securing of these units to one another in the stack.

When the ham, for example, has been cooked, the stack is transferred out of the cooking compartment, after which unstacking can be carried out by operations which are the reverse of those described above. The frame 7 is brought to a position above the top unit of the stack with its actuators 8 extended, and is positioned in such a way that the fingers 92 and the pins 93 are placed facing the orifices 10 and 11 respectively. The pins 8 are then operated so that they retract, in such a way that the pins 93 cause the retraction of the fingers 5 while the fingers 92 are placed in the gripping position in the orifices 10. Thus the top unit can be released and taken away to a station for the removal of the cooked ham. The operation can be repeated for all the units in the stack.

The invention is also applicable to units for molding and thermally processing food products of the type described in EP 0 888 065, in which the space separating a trough from its associated cover element forms a passage in which a heat transfer fluid can flow for the purpose of thermal processing.

In this case, the spring locking fingers can be mounted inside reservations or sealed cavities which do not open into said passages, so that the sealing of the passages is not affected.

The invention can also be applied to units in which the support for stacking the units on one another are legs, instead of plates, such as proposed in EP 0 292 417. In this case, the lock or locking means are advantageously built into these legs.

1. A unit for molding food products, the unit comprising: a set of molds, the molds comprising a set of troughs arranged horizontally, side by side and parallel to one another, the troughs having bases downwardly oriented and openings upwardly oriented, the set of molds fixed to a support enabling the unit to be stacked on a second unit, the unit further comprising a built-in spring lock which acts automatically, by downward vertical pressure, to solidly connect the unit to a similar unit located below and/or above it, to ensure that the respective support thereof is fully supported, the lock being subsequently retractable in order to detach the unit from the similar unit and to unstack the unit from the similar unit.

2. The molding unit of claim 1, wherein the built-in spring lock comprises movable locking fingers stressed by a spring and which, under the action of the spring, occupy a first position in which the locking fingers interact with a stop element of the similar unit, to retain the unit and the similar unit to one another in the vertical direction, and a second position, in which the locking fingers are moved away from said stop element to allow the unit and the similar unit to be detached from one another.

3. The molding unit of claim 2, wherein said movable locking fingers comprise pivoting levers.

4. The molding unit of claim 3, wherein the stop element is built into the support and each of said movable locking fingers has a stop surface area bearable against a stop element of a similar unit located above it, to keep the unit pressed against the similar unit located above it, when a respective movable finger occupies its locking position.

5. The molding unit of claim 4, comprising four movable locking fingers substantially arranged in a rectangular formation when seen from above.

6. The molding unit of claim 5, wherein said movable locking fingers project slightly toward the outside of the unit when said movable locking fingers occupy their locking position, and are retracted by pushing toward the inside of the unit.

7. The molding unit of claim 6, wherein said support comprises a pair of support plates fixed transversely to each end of the set of troughs, the support plates bent having a cross section comprising an upper vertical rectilinear part, a first substantially horizontal outwardly oriented support area, a lower vertical rectilinear part, a second substantially horizontal inwardly oriented support area, narrower than the first support area, and a bottom end portion oriented obliquely upwardly and outwardly, wherein said movable locking fingers are mounted on said upper part of each of said support plates, with the spring tending to move said movable locking fingers outward over a limited path, the bases of the support plates, at the level of said bottom end portions, act as stop elements for the locking fingers of the underlying ends.

8. The molding unit of claim 7, wherein said locking fingers have a shaped outer surface forming a ramp slideable against a base of a plate of a unit located above it, at the level of their said bottom end portion, for progressively and temporarily pushing the locking fingers toward the inside, to retract the locking fingers, when a supporting state is established by a vertical downward movement of this unit, resulting in the automatic locking.

9. The molding unit of claim 8, further comprising openings formed in said lower parts of said plates when the unit is correctly placed on another underlying unit, said openings being positioned opposite the locking fingers of the underlying unit, allowing passage of unlocking members to move horizontally and transversely with respect to the plates.

10. The molding unit of claim 9, comprising four locking fingers arranged in a rectangular formation, in the vicinity of its corners, on the outside of the set of troughs.

11. A combination comprising:
the unit of claim 1, solidly connected to a set of cover elements, the combination comprising an equal number of troughs and cover elements, with a respective cover element extending under a corresponding trough base whereby each cover element engages in the trough opening of an underlying unit with which it is aligned when the unit is stacked on the underlying unit.

12. The molding unit of claim 2, wherein the stop element is built into the support and each of said movable locking fingers has a stop surface area bearable against a stop element of a similar unit located above it, to keep the unit pressed against the similar unit located above it, when a respective movable finger occupies its locking position.

13. The molding unit of claim 2, comprising four movable locking fingers substantially arranged in a rectangular formation when seen from above.

14. The molding unit of claim 2, wherein said movable locking fingers project slightly toward the outside of the unit when said movable locking fingers occupy their locking position, and are retracted by pushing toward the inside of the unit.

15. The molding unit of claim 2, wherein said support comprises a pair of support plates fixed transversely to each end of the set of troughs, the support plates bent having a cross section comprising an upper vertical rectilinear part, a first substantially horizontal outwardly oriented support area, a lower vertical rectilinear part, a second substantially horizontal inwardly oriented support area, narrower than the first support area, and a bottom end portion oriented obliquely upwardly and outwardly, wherein said movable locking fingers are mounted on said upper part of each of said support plates, with the spring tending to move said movable locking fingers outward over a limited path, and, the bases of the support plates, at the level of said bottom end portions, act as stop elements for the locking fingers of the underlying ends.

16. The molding unit of claim 15, wherein said locking fingers have a shaped outer surface forming a ramp slideable against a base of a plate of a unit located above it, at the level of their said bottom end portion, for progressively and temporarily pushing the locking fingers toward the inside, to retract the locking fingers, when a supporting state is established by a vertical downward movement of this unit, resulting in the automatic locking.

17. The molding unit of claim 7, further comprising openings formed in said lower parts of said plates when the unit is correctly placed on another underlying unit, said openings being positioned opposite the locking fingers of the underlying unit, allowing passage of unlocking members to move horizontally and transversely with respect to the plates.

18. The molding unit of claim 7, comprising four locking fingers arranged in a rectangular formation, in the vicinity of its corners, on the outside of the set of troughs.

19. A combination comprising:
the unit of claim 2, connected solidly to a set of cover elements, the combination comprising an equal number of troughs and cover elements with a respective cover element extruding under a corresponding trough base whereby each cover element engaged in the trough opening of an underlying unit with which it is aligned when the unit is stacked in the underlying unit.
